(19) United States
(12) Patent Application Publication
(10) Pub. No.: US 2026/0296805 A1
(43) Pub. Date: Oct. 1, 2026

(54) GLASS PLATE LOADING APPARATUS AND METHOD OF MANUFACTURING A GLASS PLATE USING THE SAME

(71) Applicant: Samsung Display Co., Ltd., Yongin-Si (KR)

(72) Inventors: Junho Lee, Yongin-si (KR); SEUNGHO KIM, Yongin-si (KR); Jinsu Nam, Yongin-si (KR); GYUIN SHIM, Yongin-si (KR); JIN-WON JANG, Yongin-si (KR); YOUNG-SI JO, Yongin-si (KR)

(21) Appl. No.: 19/415,792

(22) Filed: Dec. 11, 2025

(30) Foreign Application Priority Data
Mar. 27, 2025 (KR) 10-2025-0039508

(51) Int. Cl. B65G 49/06; B65D 85/48

(52) U.S. Cl. CPC B65G 49/064; B65D 85/48; B65G 49/062

(57) ABSTRACT

A glass plate loading apparatus comprises a frame including a support part, a first wall connected to the support part, and a second wall connected to the support part and facing the first wall, and a first porous support placed in a space between the first wall and the second wall and disposed between a first glass plate and a second glass plate loaded on the frame. The first glass plate and the second glass plate may be spaced apart from each other by the first porous support, and the first porous support may have a porous structure in which a plurality of pores are defined.

### CROSS-REFERENCE TO RELATED APPLICATION

This application claims priority under 35 USC § 119 to Korean Patent Application No. 10-2025-0039508 filed on Mar. 27, 2025 in the Korean Intellectual Property Office (KIPO), the entire disclosure of which is incorporated herein by reference.

### BACKGROUND

### 1. Field

Embodiments of the present disclosure relate to a glass plate loading apparatus and a method of manufacturing a glass plate using the glass plate loading apparatus.

### 2. Description of the Related Art

A display device is employed in a wide range of multimedia devices such as a television, a mobile phone, a tablet computer, a gaming console, and the like in order to provide visual information (or referred to as image information) to a user. Recently, various forms of flexible display devices capable of folding or bending have been developed.

A flexible display device may include a display module and a window that can be foldable or bendable. The window included in the flexible display device effectively transmits the visual information provided from the display module to the outside and protects the display module from external impacts.

A glass plate used for the window of the flexible display device is required to be foldable or bendable while also having excellent strength against external shocks (or impacts). An ultra-thin glass plate that is chemically strengthened may be used for the window. As a result, extensive development has been directed toward manufacturing processes capable of efficiently producing the chemically strengthened ultra-thin glass plate.

### SUMMARY

An embodiment of the present disclosure provides a glass plate loading apparatus.

Furthermore, an embodiment of the present disclosure provides a method of manufacturing a glass plate using the glass plate loading apparatus.

However, inventive concepts of the present disclosure are not limited to the embodiments described in the present disclosure and may be variously extended without departing from the spirit and scope of the present disclosure.

According to an embodiment of the present disclosure, a glass plate loading apparatus comprises a frame including a support part, a first wall connected to the support part, and a second wall connected to the support part and facing the first wall, and a first porous support placed in a space between the first wall and the second wall and disposed between a first glass plate and a second glass plate loaded on the frame.

The first glass plate and the second glass plate may be spaced apart from each other by the first porous support.

The first porous support may be in contact with at least one of the first glass plate and the second glass plate.

A Mohs hardness of the first porous support may be less than a Mohs hardness of the first glass plate and a Mohs hardness of the second glass plate.

The first porous support may have a porous structure in which a plurality of pores are defined.

A porosity of the first porous support may be between 50% and 90%.

The first porous support may include at least one selected from a group consisting of polyurethane foam, polystyrene, silica aerogel, polypropylene, aluminum foam, and polyvinyl alcohol.

The first porous support may not chemically react with a strengthening solution that strengthens the first and second glass plates.

The first porous support may not be deformed at a strengthening temperature for strengthening the first and second glass plates.

The first porous support may cover a portion of the first glass plate and a portion of the second glass plate.

The first porous support may include a first-first porous support covering a first area of the first glass plate, and a first-second porous support covering a second area of the first glass plate, the second area being spaced apart from the first area.

The first porous support may not cover a folding area defined between the first area and the second area.

The glass plate loading apparatus may further include a second porous support placed in the space between the first wall and the second wall and disposed between the second glass plate and a third glass plate loaded on the frame.

The glass plate loading apparatus may further include an outer porous support disposed between the first wall and the first glass plate.

According to an embodiment of the present disclosure, a method of manufacturing a glass plate comprises preparing a frame including a support part, a first wall connected to the support part, and a second wall connected to the support part and facing the first wall, loading a plurality of glass plates on the frame, inserting a plurality of porous supports into the frame, and performing a strengthening process on the glass plates.

Each of the plurality of porous supports may be disposed between adjacent ones among the plurality of glass plates, and the adjacent glass plates may be spaced apart from each other by at least on porous support among the plurality of porous supports.

The plurality of porous supports may be inserted after the plurality of glass plates are loaded on the frame.

The performing the strengthening process may include performing a pre-heating process during which the plurality of glass plates are heated to a first strengthening temperature, performing an ion exchange process during which the plurality of glass plates are immersed in a strengthening solution, and performing a post-heating process during which the plurality of glass plates are heated to a second strengthening temperature.

The plurality of porous supports may not chemically react with the strengthening solution.

The plurality of porous supports may not be deformed at the first strengthening temperature and the second strengthening temperature.

A glass plate loading apparatus according to an embodiment may include a frame and porous supports. The porous supports may be disposed between adjacent glass plates loaded on the glass plate loading apparatus.

The porous supports may physically support the glass plates while a strengthening process is performed on the glass plates. As a result, the glass plates GL may maintain their shape without sagging or bending during the strengthening process. In addition, the porous supports PS may prevent the glass plates GL from being in contact with each other by maintaining a certain separation distance between the porous supports PS.

Furthermore, the porous supports may have a porous structure in which a plurality of pores are defined. The minimum porosity of each of the porous supports may be set to enable the movement of alkali ions through the porous supports. Accordingly, the porous supports may not affect the strengthening process, and the strengthening process for the glass plates may be performed smoothly.

Features of the present disclosure are not limited to the described above and may be variously extended without departing from the spirit and scope of the present disclosure.

### BRIEF DESCRIPTION OF THE DRAWINGS

FIG. 1 is a perspective view illustrating a glass plate loading apparatus according to an embodiment.

FIG. 2 is a side view of the glass plate loading apparatus illustrated in FIG. 1.

FIG. 3 is a top plan view of the glass plate loading apparatus illustrated in FIG. 1.

FIGS. 4 to 10 are perspective views illustrating a method of manufacturing a glass plate using the glass plate loading apparatus illustrated in FIG. 1.

FIG. 11 is a perspective view illustrating a glass plate loading apparatus according to an embodiment.

FIG. 12 is a side view of the glass plate loading apparatus illustrated in FIG. 11.

FIG. 13 is a top plan view of the glass plate loading apparatus illustrated in FIG. 11.

FIG. 14 is a perspective view illustrating a glass plate loading apparatus according to an embodiment.

FIG. 15 is a side view of the glass plate loading apparatus illustrated in FIG. 14.

FIG. 16 is a side view of the glass plate loading apparatus illustrated in FIG. 14.

FIG. 17 is a block diagram of an electronic device according to an embodiment.

FIG. 18 are schematic diagrams illustrating various examples in which the electronic device of FIG. 17 is implemented.

### DETAILED DESCRIPTION OF THE EMBODIMENTS

Hereinafter, embodiments of the present disclosure will be described in more detail with reference to the accompanying drawings. Identical components in the drawings will be represented using the same reference numerals, and redundant descriptions of the identical components will be omitted.

In the specification, it should be understood that the expression “at least one of A and B” may refer to “at least A but not B,” “at least B but not A,” or “at least A and at least B.”

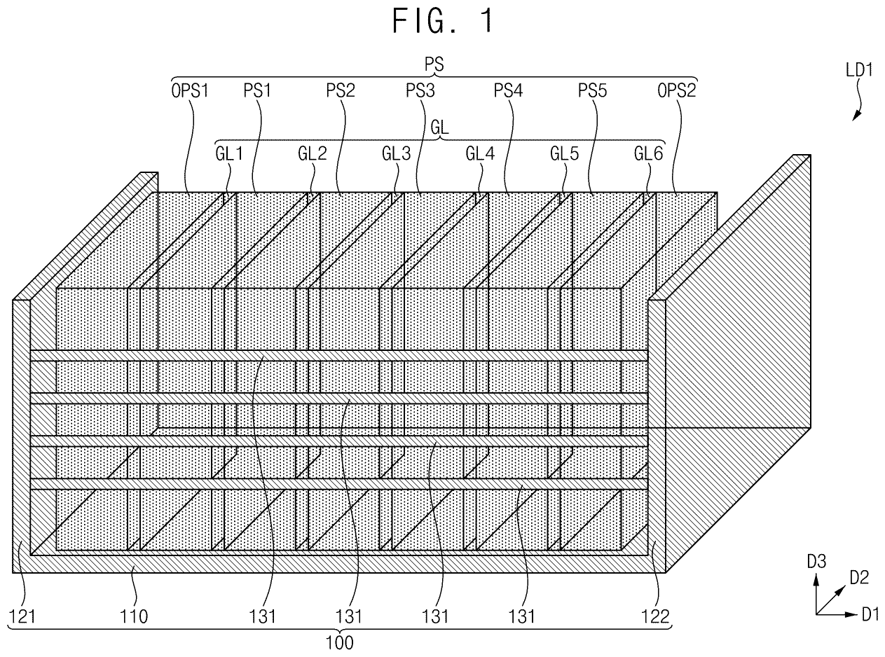

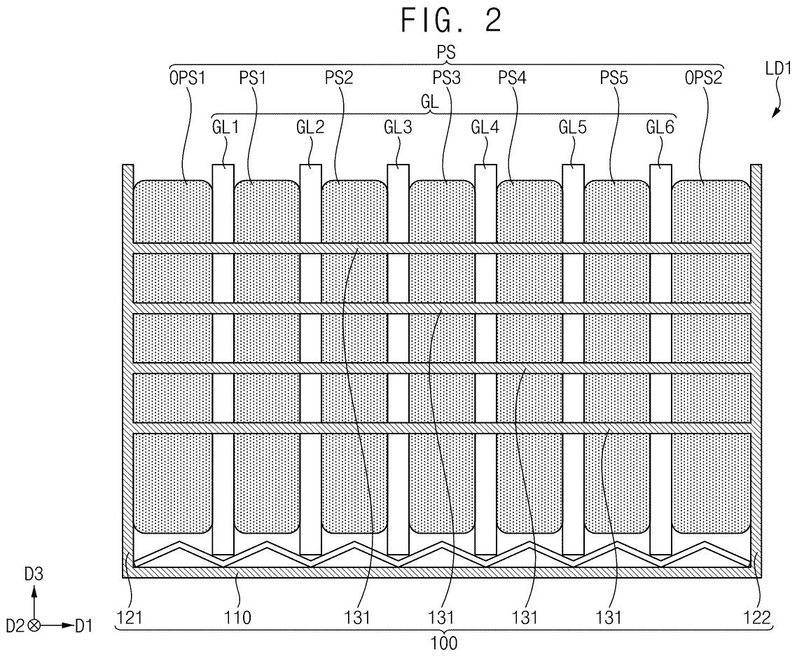

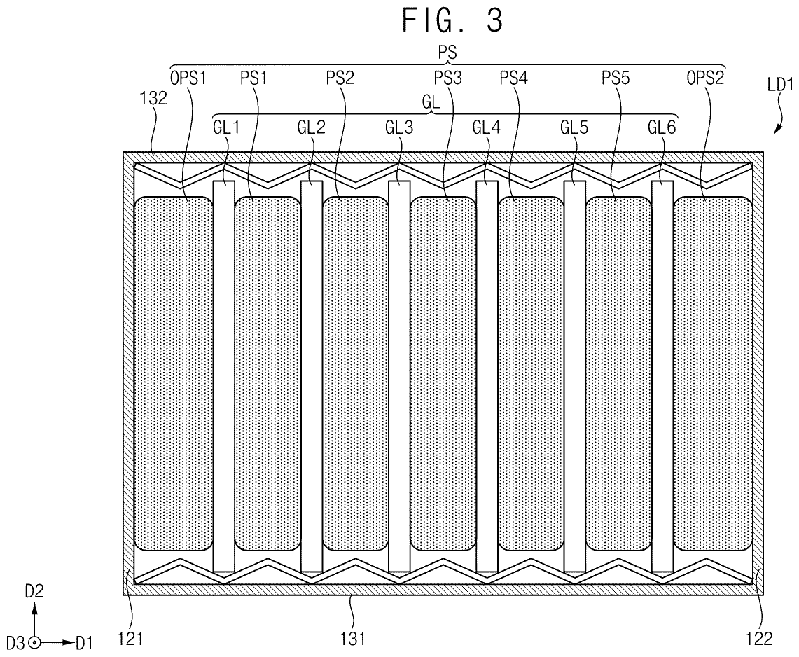

FIG. 1 is a perspective view illustrating a glass plate loading apparatus according to an embodiment, FIG. 2 is a side view of the glass plate loading apparatus shown in FIG. 1, and FIG. 3 is a top plan view of the glass plate loading apparatus shown in FIG. 1.

Referring to FIGS. 1 to 3, the glass plate loading apparatus LD1 may accommodate a plurality of glass plates GL. The glass plate loading apparatus LD1 may include a frame 100 and a plurality of porous supports PS.

In an embodiment, the frame 100 may include a support part 110, a first wall 121, a second wall 122, first jigs 131, and second jigs 132. Although the second jigs 132 are not shown clearly in FIGS. 1 and 2, the second jigs 132 are arranged in an opposite side where the first jigs are arranged along a second direction D2 (see FIG. 3). The frame 100 may include a material having a predetermined rigidity, such as metal. The support part 110, the first wall 121, and the second wall 122 may define a space in which the glass plates GL are loaded or accommodated, and the first jigs 131 and the second jigs 132 may secure the glass plates GL in position within the space defined by the support part GL together with the first wall 121 and the second wall 122.

The support part 110 may define a planar surface extending along a first direction D1 and a second direction D2 that intersects the first direction D1. The support part 110 may form a bottom surface of the frame 100 and may provide the structural support for the glass plates GL. For example, zigzag-shaped supporting structures may be formed on the support part 110, and the glass plates GL may be supported in the spaces between these supporting structures.

The first wall 121 may be coupled to one end of the support part 110 and may extend in a third direction D3 that intersects the first and second directions D1 and D2. The first wall 121 may have a lattice shape formed by a plurality of intersecting metal wires or may have a single solid plate shape.

The second wall 122 may be coupled to the other end of the support part 110, may be spaced apart from the first wall 121 in the first direction D1, and may extend in the third direction D3. The second wall 122 may face the first wall 121 along the first direction D1. The second wall 122 may have a lattice shape formed by a plurality of intersecting metal wires or may have a single solid plate shape.

The first jigs 131 may be connected to the first wall 121 and the second wall 122 and may extend in the first direction D1. For example, four first jigs 131 may be provided on the frame 100. The first jigs 131 may secure the glass plates GL in position. For example, the first jigs 131 may include zigzag-shaped supporting structures, and the glass plates GL may be secured in position between facing zigzag shaped supporting structures of the first jigs 131 and the second jigs 132.

The second jigs 132 may be connected to the first wall 121 and the second wall 122 and may extend in the first direction D1. For example, four second jigs 132 may be provided on the frame 100. The second jigs 132 may be spaced apart from the first jigs 131 and may face the first jigs 131 in the second direction D2. The second jigs 132 may secure the glass plates GL in position. For example, the second jigs 132 may also include zigzag-shaped supporting structures, and the glass plates GL may be secured in position between facing zigzag shaped supporting structures of the first jigs 131 and the second jigs 132.

In an embodiment, the glass plates GL may be ultra-thin glass (UTG) plates used in a flexible display device capable of folding or bending. The glass plates GL may include a first glass plate GL1, a second glass plate GL2, a third glass plate GL3, a fourth glass plate GL4, a fifth glass plate GL5, and a sixth glass plate GL6.

Each of the first to sixth glass plates GL1, GL2, GL3, GL4, GL5, and GL6 may have a planar shape defined by the second direction D2 and the third direction D3 and have a thickness in the first direction D1. For example, the thickness of each of the first to sixth glass plates GL1, GL2, GL3, GL4, GL5, and GL6 may be approximately 30 μm to 100 μm. A planar area of each of the first to sixth glass plates GL1, GL2, GL3, GL4, GL5, and GL6 may be approximately 150 cm² or more, and preferably approximately 500 cm² or more. Each of the first to sixth glass plates GL1, GL2, GL3, GL4, GL5, and GL6 may be a large-area glass substrate, and a ratio of an area (i.e., cm²) to a thickness (i.e., μm) of each of the first to sixth glass plates GL1, GL2, GL3, GL4, GL5, and GL6 may be greater than 5.

The first to sixth glass plates GL1, GL2, GL3, GL4, GL5, and GL6 may be arranged parallel to each other in the first direction D1 and may be loaded on the frame 100. In addition, each of the first to sixth glass plates GL1, GL2, GL3, GL4, GL5, and GL6 may be secured by the zigzag-shaped supporting structures formed on the frame 100. For example, each of the first to sixth glass plates GL1, GL2, GL3, GL4, GL5, and GL6 may be secured in position using the zigzag-shaped supporting structures of the support part 110, and using the facing zigzag-shaped supporting structures of the first jigs 131 and the second jigs 132.

The porous supports PS may include a first outer porous support OPS1, a first porous support PS1, a second porous support PS2, a third porous support PS3, a fourth porous support PS4, a fifth porous support PS5, and a second outer porous support OPS2.

Each of the first to fifth porous supports PS1, PS2, PS3, PS4, and PS5 may have a planar shape defined by the second direction D2 and the third direction D3 and may have a thickness in the first direction D1. For example, a thickness of each of the first to fifth porous supports PS1, PS2, PS3, PS4, and PS5 may correspond to a gap between the glass plates GL.

The first to fifth porous supports PS1, PS2, PS3, PS4, and PS5 may be arranged parallel to each other in the first direction D1 and may be accommodated in the frame 100. For example, the first to fifth porous supports PS1, PS2, PS3, PS4, and PS5 are placed in a space between the first wall 121 and the second wall 122.

In an embodiment, the first to fifth porous supports PS1, PS2, PS3, PS4, and PS5 may be placed between adjacent ones of the first to sixth glass plates GL1, GL2, GL3, GL4, GL5, and GL6. Specifically, the first porous support PS1 may be disposed or interposed between the first and second glass plates GL1 and GL2, the second porous support PS2 may be disposed or interposed between the second and third glass plates GL2 and GL3, the third porous support PS3 may be disposed or interposed between the third and fourth glass plates GL3 and GL4, the fourth porous support PS4 may be disposed or interposed between the fourth and fifth glass plates GL4 and GL5, and the fifth porous support PS5 may be disposed or interposed between the fifth and sixth glass plates GL5 and GL6.

The porous supports PS may serve to maintain a space between the glass plates GL. In an embodiment, the glass plates GL may be separated from one another by the porous supports PS. Each of the porous supports PS may have a predetermined thickness to establish and maintain a desired separation distance between adjacent glass plates GL.

For example, the first glass plate GL1 and the second glass plate GL2 may be spaced apart from each other by the first porous support PS1, the second glass plate GL2 and the third glass plate GL3 may be spaced apart from each other by the second porous support PS2, the third glass plate GL3 and the fourth glass plate GL4 may be spaced apart from each other by the third porous support PS3, the fourth glass plate GL4 and the fifth glass plate GL5 may be spaced apart from each other by the fourth porous support PS4, and the fifth glass plate GL5 and the sixth glass plate GL6 may be spaced apart from each other by the fifth porous support PS5.

The porous supports PS may support the glass plates GL. In an embodiment, the porous supports PS may be in contact with at least one of the glass plates GL. The porous supports PS may have a predetermined strength to support the glass plates GL.

For example, the first porous support PS1 may be in contact with at least one of the first and second glass plates GL1 and GL2, the second porous support PS2 may be in contact with at least one of the second and third glass plates GL2 and GL3, the third porous support PS3 may be in contact with at least one of the third and fourth glass plates GL3 and GL4, the fourth porous support PS4 may be in contact with at least one of the fourth and fifth glass plates GL4 and GL5, and the fifth porous support PS5 may be in contact with at least one of the fifth and sixth glass plates GL5 and GL6.

In addition, the first porous support PS1 may cover a portion of a planar surface of the first glass plate GL1 and a portion of a planar surface of the second glass plate GL2, the second porous support PS2 may cover a portion of a planar surface of the second glass plate GL2 and a portion of a planar surface of the third glass plate GL3, the third porous support PS3 may cover a portion of a planar surface of the third glass plate GL3 and a portion of a planar surface of the fourth glass plate GL4, the fourth porous support PS4 may cover a portion of a planar surface of the fourth glass plate GL4 and a portion of a planar surface of the fifth glass plate GL5, and the fifth porous support PS5 may cover a portion of a planar surface of the fifth glass plate GL5 and a portion of a planar surface of the sixth glass plate GL6. However, the present disclosure is not limited thereto. For example, the first porous support PS1 may cover an entire surface of the first glass plate GL1 and an entire surface of the second glass plate GL2, the second porous support PS2 may cover an entire surface of the second glass plate GL2 and an entire surface of the third glass plate GL3, the third porous support PS3 may cover an entire surface of the third glass plate GL3 and an entire surface of the fourth glass plage GL4, the fourth porous support PS4 may cover an entire surface of the fourth glass plate GL4 and an entire surface of the fifth glass plate GL5, and the fifth porous support PS5 may cover an entire surface of the fifth glass plate GL5 and an entire surface of the sixth glass plate GL6.

The porous supports PS may not damage the glass plates GL. In an embodiment, a Mohs hardness of each of the porous supports PS may be less than a Mohs hardness of each of the glass plates GL. As a result, the glass plates GL may not be damaged by the porous supports PS.

A strengthening process may be performed on the glass plates GL loaded on the frame 100. Through the strengthening process, a compressive stress may be generated on a surface of each of the glass plates GL, such that a bending strength and an impact resistance of the glass plates GL may be improved.

In an embodiment, the strengthening process may be an ion exchange process. In an embodiment, the glass plates GL may be heated to a predetermined strengthening temperature and may be immersed in a strengthening solution containing an alkali salt.

The strengthening process for the glass plates GL may be performed while the porous supports PS remain interposed between the glass plates GL. Accordingly, the porous supports PS may be formed of a material that does not chemically react with the strengthening solution and is not deformed at the strengthening temperature.

Each of the porous supports PS may have a porous structure in which a plurality of pores are defined. For example, each of the porous supports PS may include at least one of polyurethane foam, polystyrene, silica aerogel, polypropylene, aluminum foam, and polyvinyl alcohol.

A minimum porosity of each of the porous supports PS may be set to enable the ion exchange. For example, the minimum porosity of each of the porous supports PS may be set to allow alkali ions (e.g., Na⁺ and K⁺) used in the ion exchange process to be able to migrate through the respective porous supports PS. A maximum porosity of each of the porous supports PS may be set to be able to support the glass plates GL. In an embodiment, the porosity of each of the porous supports PS may be approximately 50% to 90%.

The first outer porous support OPS1 may be disposed or interposed between the first wall 121 and the first glass plate GL1. The first outer porous support OPS1 may have substantially the same shape as the first porous support PS1 and may include substantially the same material as the first porous support PS1.

The second outer porous support OPS2 may be disposed or interposed between the second wall 122 and the sixth glass plate GL6. The second outer porous support OPS2 may have substantially the same shape as the first outer porous support OPS1 and may include substantially the same material as the first outer porous support OPS1.

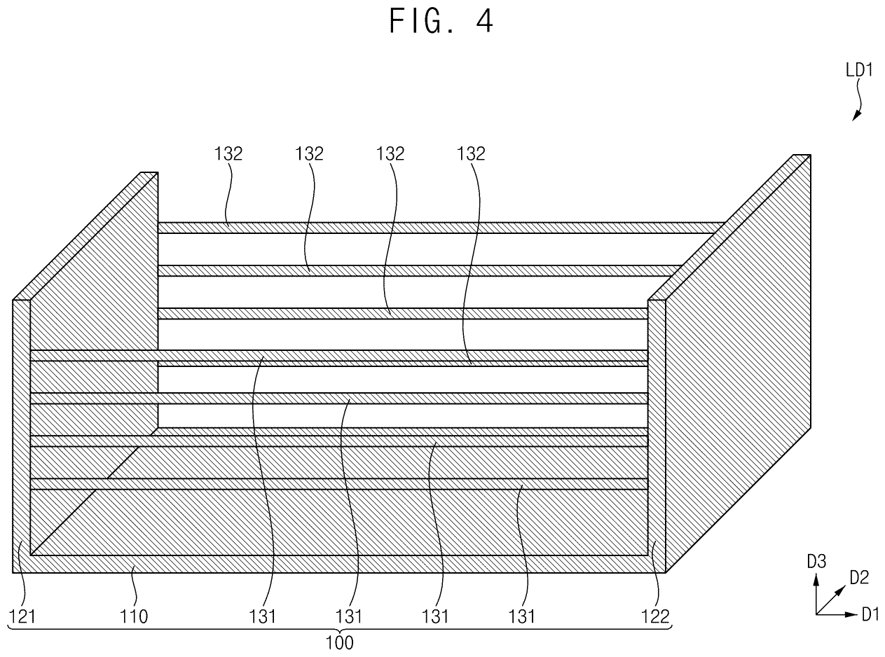

FIGS. 4 to 10 are perspective views illustrating a method of manufacturing a glass plate using the glass plate loading apparatus shown in FIG. 1.

Referring to FIG. 4, the frame 100 including the support part 110, the first wall 121, the second wall 122, the first jigs 131, and the second jigs 132 may be prepared.

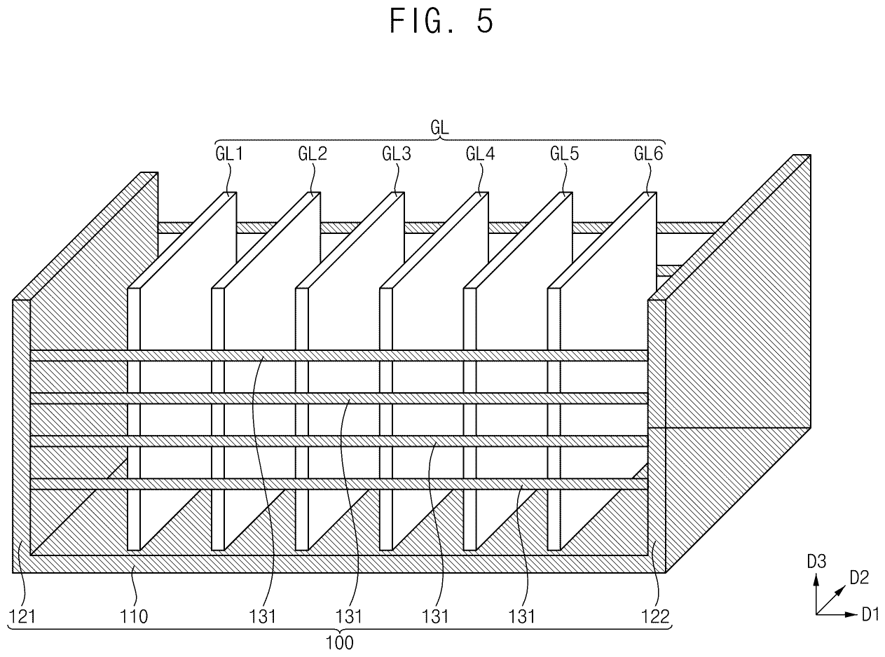

Referring to FIG. 5, the glass plates GL may be loaded on the frame 100. The glass plates GL may be supported by the support part 110 and may be secured in position by the first and second jigs 131 and 132. The glass plates GL may be arranged parallel to each other in the first direction D1 with a constant interval between them.

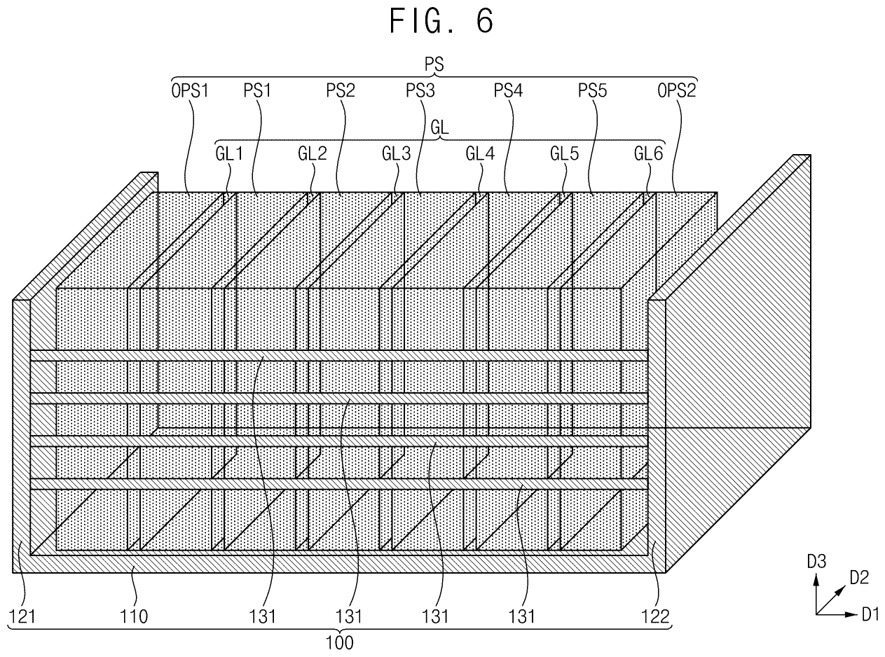

Referring to FIG. 6, the porous supports PS may be inserted into the frame 100. Each of the porous supports PS may be disposed or interposed between adjacent ones of the glass plates GL, and the glass plates GL may be spaced apart from each other by the porous supports PS.

In an embodiment, as shown in FIGS. 5 and 6, the porous supports PS may be inserted (or placed) after the glass plates GL are loaded (or placed). However, the present disclosure is not limited thereto. For example, the porous supports PS may be placed first, and then the glass plates GL may be placed between adjacent ones of the porous supports PS. For example, the porous supports PS and the glass plates GL may be placed alternately.

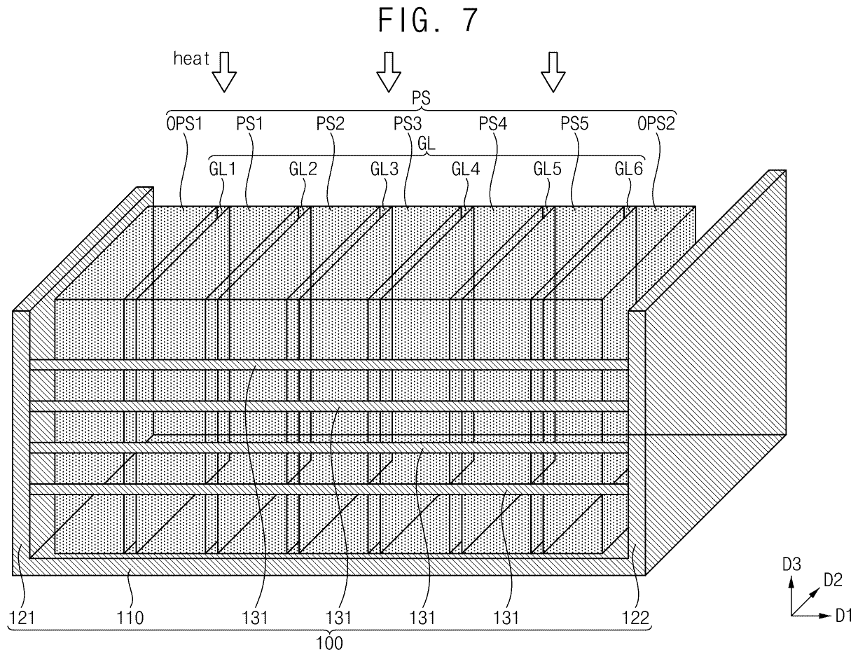

Referring to FIG. 7, a pre-heating process during which the glass plates GL are heated to a first strengthening temperature may be performed. For example, the first strengthening temperature may be approximately 380° C. to 400° C., and the preheating process may be performed for approximately 20 minutes. In an embodiment, the porous supports PS may be formed of a material that is not deformed at the first strengthening temperature.

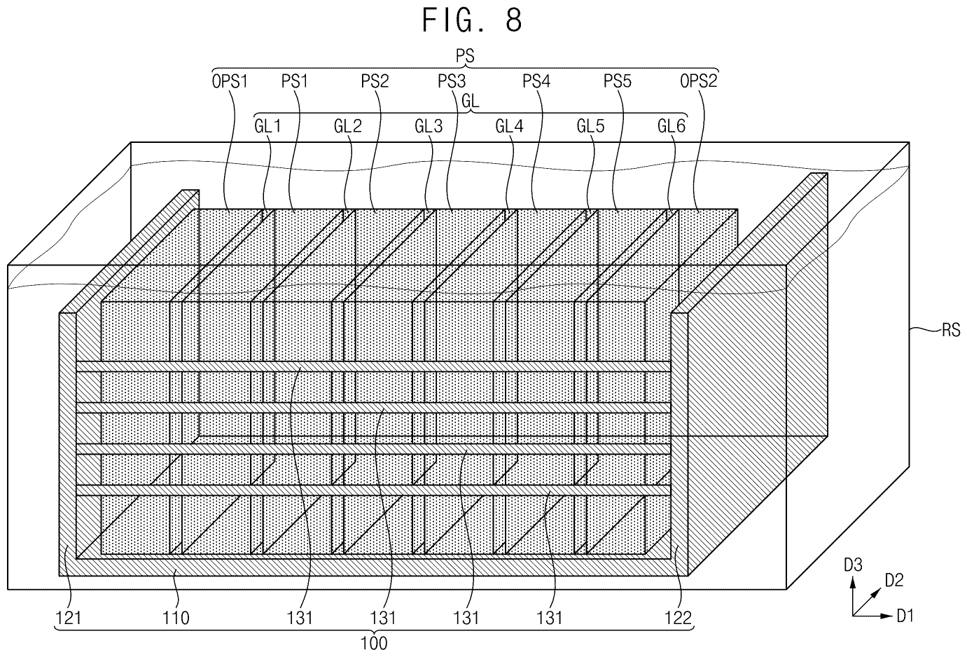

Referring to FIG. 8, an ion exchange process in which the glass plates GL are immersed in a strengthening solution RS may be performed. In an embodiment, the strengthening solution RS may be a molten alkali salt solution containing alkali ions and maintained at a temperature of approximately 400° C. For example, the strengthening solution RS may include a molten potassium nitrate (KNO₃) solution. During the ion exchange process, alkali ions (e.g., K⁺) from the strengthening solution RS may be exchanged with alkali ions (e.g., Na⁺) present on the surface of the glass plates GL. Accordingly,, the porous supports PS may have the minimum porosity to enable the ion exchange through the porous supports PS. In addition, the porous supports PS may be formed of a material that does not chemically react with the strengthening solution RS.

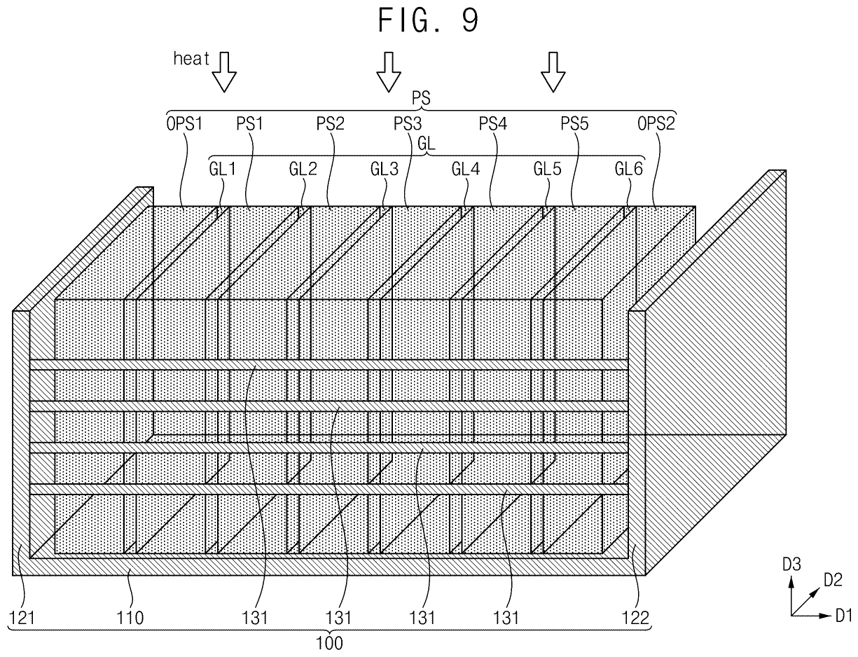

Referring to FIG. 9, a post-heating process in which the glass plates GL may be heated to a second strengthening temperature may be performed. For example, the second strengthening temperature may be approximately 360° C. to 390° C., and the post-heating process may be performed for approximately 2 minutes. In an embodiment, the porous supports PS may be formed of a material that is not deformed at the second strengthening temperature.

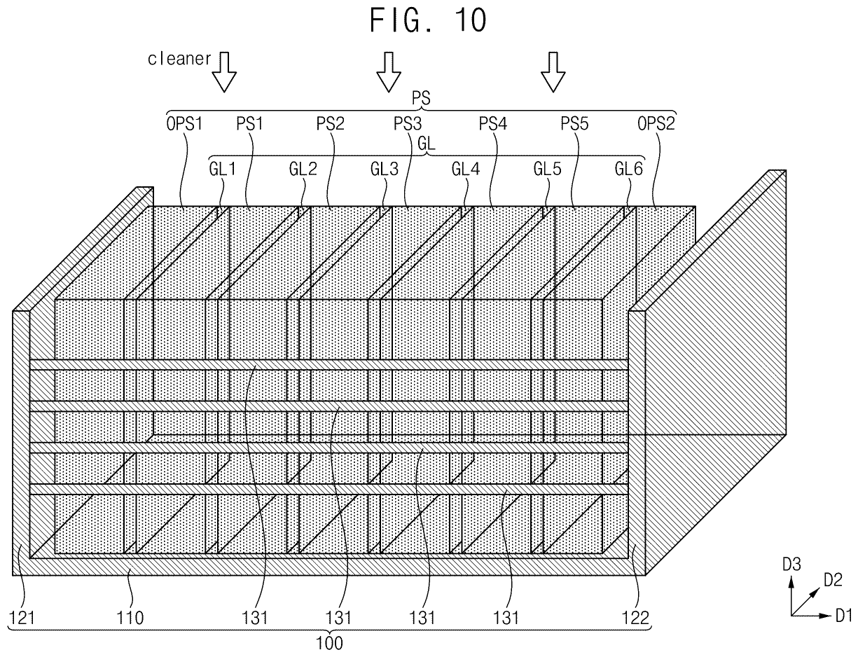

Referring to FIG. 10, the glass plates GL may be cleaned. In an embodiment, as shown in FIG. 10, the glass plates GL may be cleaned while the porous supports PS are inserted. However, the present disclosure is not limited thereto. For example, the glass plates GL may be cleaned after the porous supports PS are removed from the frame 100.

The glass plate loading apparatus LD1 may include the frame 100 and the porous supports PS. The porous supports PS may be interposed between the glass plates GL loaded on the glass plate loading apparatus LD1.

The porous supports PS may physically support the glass plates GL while the strengthening process is performed on the glass plates GL. As a result, the glass plates GL may maintain their shape without sagging or bending during the strengthening process. In addition, the porous supports PS may prevent the glass plates GL from being in contact with each other by maintaining a certain separation distance between the porous supports PS.

In addition, the porous supports PS may have the porous structure in which a plurality of pores are defined. Each of the porous supports PS may have the minimum porosity to enable the alkali ions to migrate through the porous supports PS. Accordingly, the porous supports PS may not affect the strengthening process, and the strengthening process for the glass plates GL may be performed smoothly.

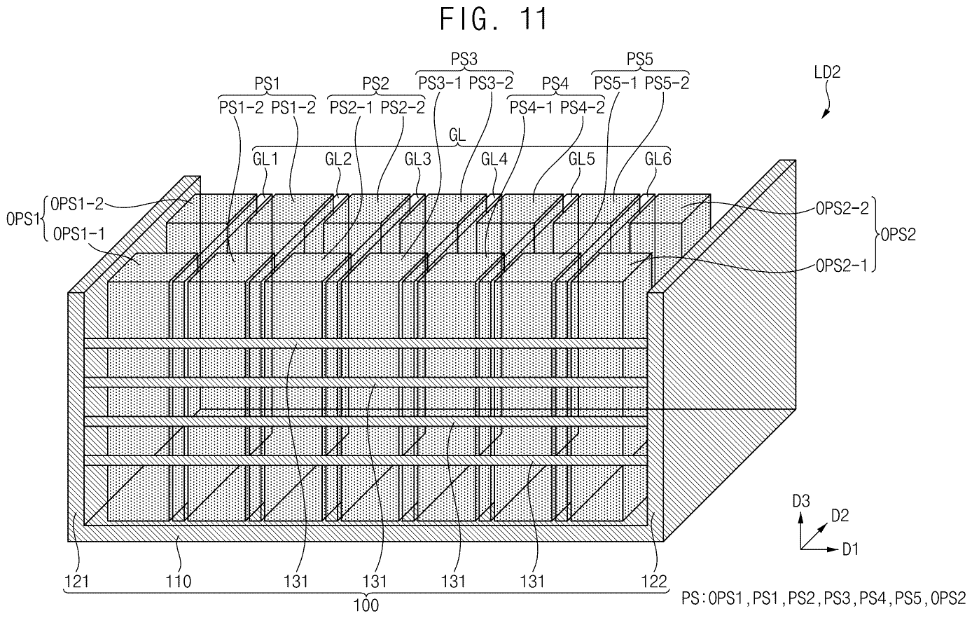

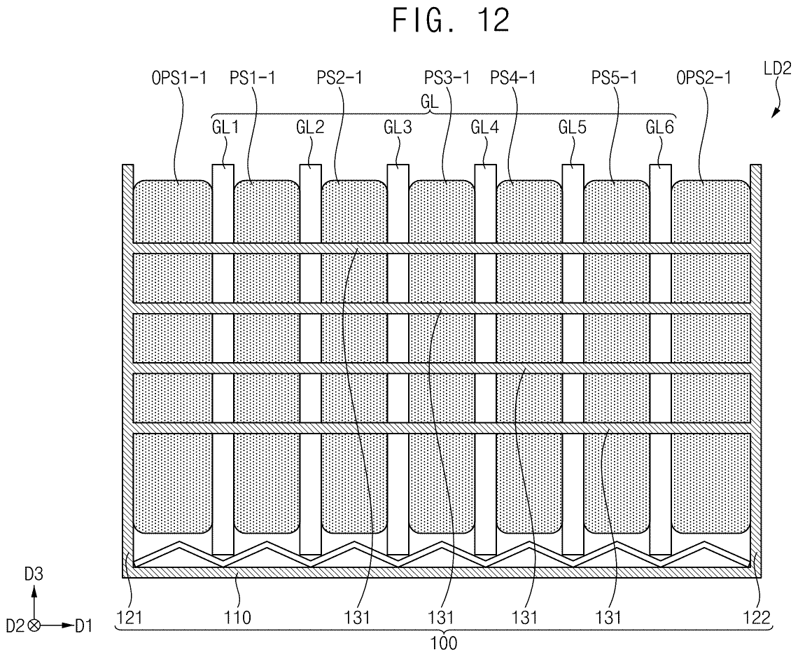

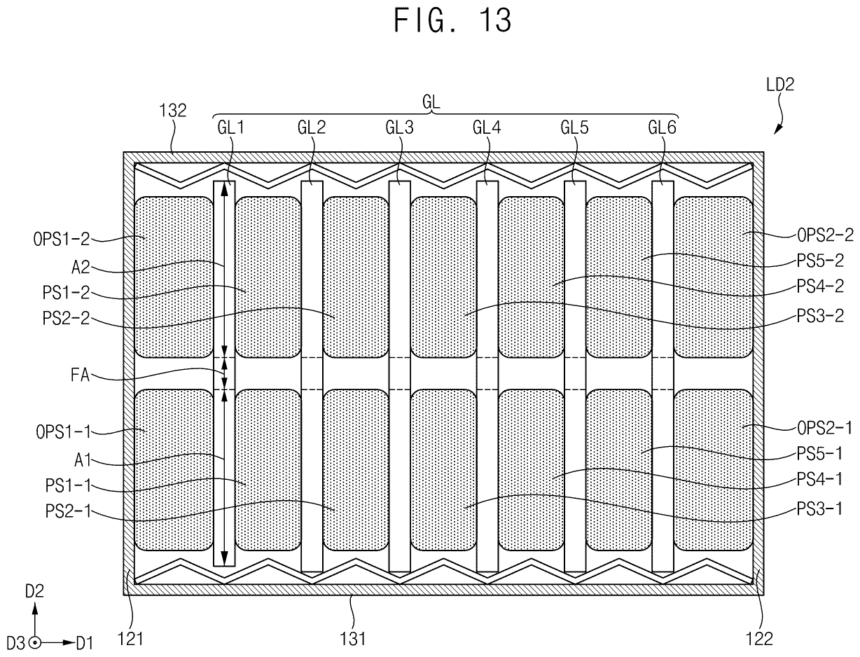

FIG. 11 is a perspective view illustrating a glass plate loading apparatus according to an embodiment, FIG. 12 is a side view of the glass plate loading apparatus shown in FIG. 11, and FIG. 13 is a top plan view of the glass plate loading apparatus shown in FIG. 11.

Referring to FIGS. 11 to 13, a plurality of glass plates GL may be loaded on the glass plate loading apparatus LD2. The glass plate loading apparatus LD2 may include a frame 100 and porous supports PS. The glass plate loading apparatus LD2 may have substantially the same structure as the glass plate loading apparatus LD1 described above with reference to FIG. 1, except for the porous supports PS.

The porous supports PS may include a first outer porous support OPS1, a first porous support PS1, a second porous support PS2, a third porous support PS3, a fourth porous support PS4, a fifth porous support PS5, and a second outer porous support OPS2.

In an embodiment, each of the porous supports PS may expose a certain portion of the glass plates GL. For example, as shown in FIG. 13, each of the first to sixth glass plates GL1, GL2, GL3, GL4, GL5, and GL6 may be divided into a first area A1, a second area A2, and a folding area FA. In an embodiment, the second area A2 may be spaced apart from the first area A1 in the second direction D2, and the folding area FA may be defined between the first area A1 and the second area A2. Although FIG. 13 shows one folding area FA between the first area A1 and the second area A2, a plurality of folding areas may be defined in each of the glass plates GL.

The first outer porous support OPS1 may include a first-first outer porous support OPS1-1 and a first-second outer porous support OPS1-2. The first porous support PS1 may include a first-first porous support PS1-1 and a first-second porous support PS1-2, the second porous support PS2 may include a second-first porous support PS2-1 and a second-second porous support PS2-2, the third porous support PS3 may include a third-first porous support PS3-1 and a third-second porous support PS3-2, the fourth porous support PS4 may include a fourth-first porous support PS4-1 and a fourth-second porous support PS4-2, and the fifth porous support PS5 may include a fifth-first porous support PS5-1 and a fifth-second porous support PS5-2. The second outer porous support OPS2 may include a second-first outer porous support OPS2-1 and a second-second outer porous support OPS2-2.

The first-first outer porous support OPS1-1 may cover the first area A1 of the first glass plate GL1. The first-second outer porous support OPS1-2 may be spaced apart from the first-first outer porous support OPS1-1 in the second direction D2 and may cover the second area A2 of the first glass plate GL1. The folding area FA of the first glass plate GL1 may be uncovered and exposed. In other words, the first outer porous support OPS1 may not cover the folding area FA.

The first-first porous support PS1-1 may cover the first area A1 of the first glass plate GL1 and the first area A1 of the second glass substrate GL2. The first-second porous support PS1-2 may be spaced apart from the first-first porous support PS1-1 in the second direction D2, and may cover the second area A2 of the first glass plate GL1 and the second area A2 of the second glass substrate GL2. The folding area FA of the first glass plate GL1 may be uncovered and exposed. In other words, the first porous support PS1 may not cover the folding area FA.

The second-first porous support PS2-1 may be spaced apart from the first-first porous support PS1-1 in the first direction D1, and may cover the first area A1 of the second glass plate GL2 and the first area A1 of the third glass plate GL3. The second-second porous support PS2-2 may be spaced apart from the first-second porous support PS1-2 in the first direction D1, and may cover the second area A2 of the second glass plate GL2 and the second area A2 of the third glass plate GL3.

The third-first porous support PS3-1 may be spaced apart from the second-first porous support PS2-1 in the first direction D1, and may cover the first area A1 of the third glass plate GL3 and the first area A1 of the fourth glass plate GL4. The third-second porous support PS3-2 may be spaced apart from the second-second porous support PS2-2 in the first direction D1, and may cover the second area A2 of the third glass plate GL3 and the second area A2 of the fourth glass plate GL4.

The fourth-first porous support PS4-1 may be spaced apart from the third-first porous support PS3-1 in the first direction D1, and may cover the first area A1 of the fourth glass plate GL4 and the first area A1 of the fifth glass plate GL5. The fourth-second porous support PS4-2 may be spaced apart from the third-second porous support PS3-2 in the first direction D1, and may cover the second area A2 of the fourth glass plate GL4 and the second area A2 of the fifth glass plate GL5.

The fifth-first porous support PS5-1 may be spaced apart from the fourth-first porous support PS4-1 in the first direction D1, and may cover the first area A1 of the fifth glass plate GL5 and the first area A1 of the sixth glass plate GL6. The fifth-second porous support PS5-2 may be spaced apart from the fourth-second porous support PS4-2 in the first direction D1, and may cover the second area A2 of the fifth glass plate GL5 and the second area A2 of the sixth glass plate GL6.

The second-first outer porous support OPS2-1 may be spaced apart from the fifth-first porous support PS5-1 in the first direction D1 and may cover the first area A1 of the sixth glass plate GL6. The second-second outer porous support OPS2-2 may be spaced apart from the fifth-second porous support PS5-2 in the first direction D1 and may cover the second area A2 of the sixth glass plate GL6.

As the porous supports PS do not cover but expose the folding area FA of the glass plates GL, the strengthening process may be more effectively applied to the folding area FA. As a result, the bending strength and the impact resistance of the folding area FA may be further improved during the strengthening process performed on the glass plates GL.

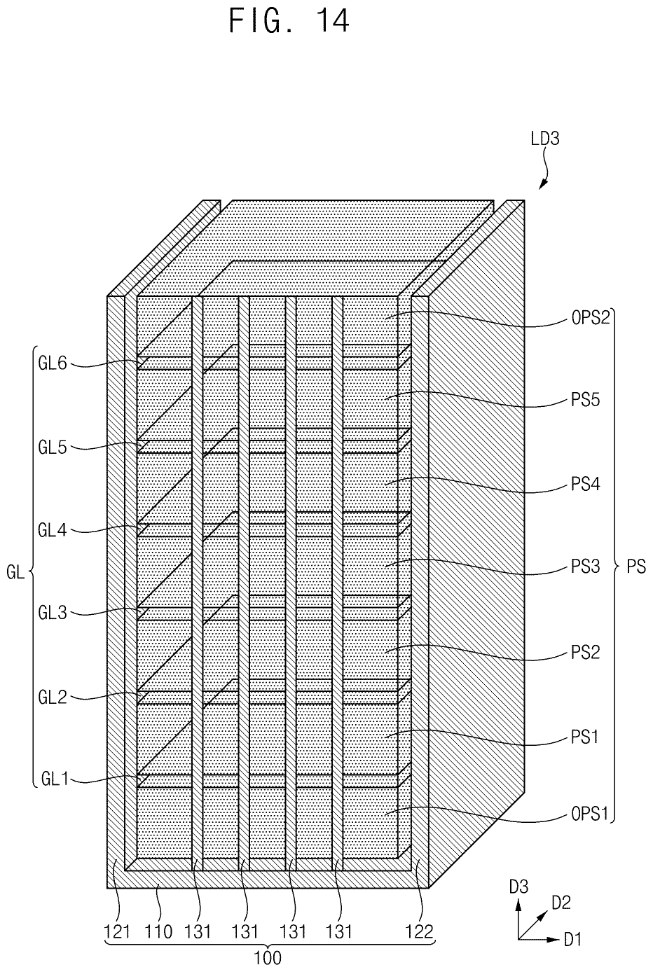

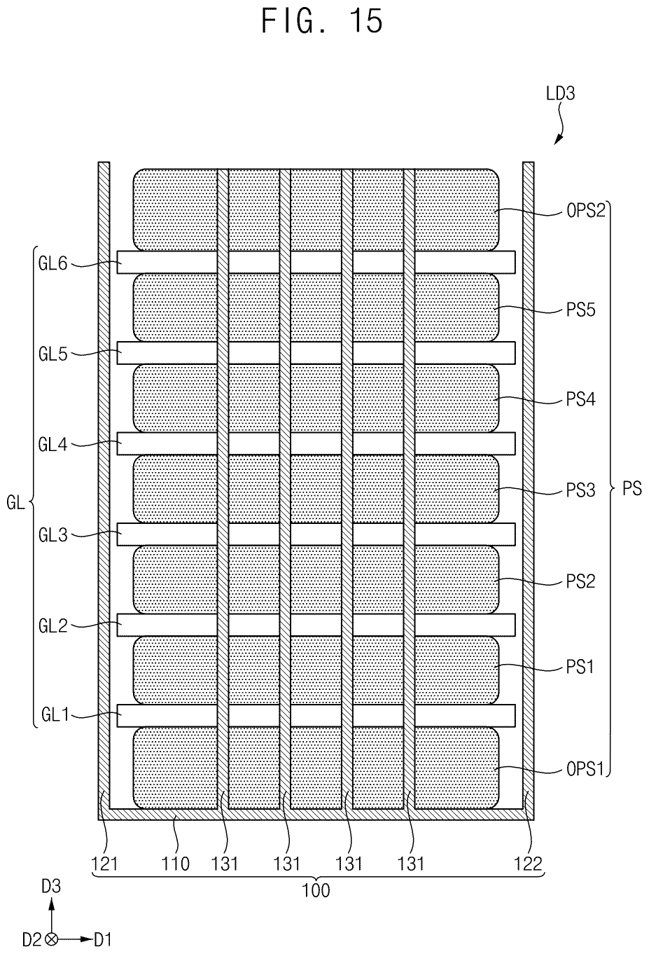

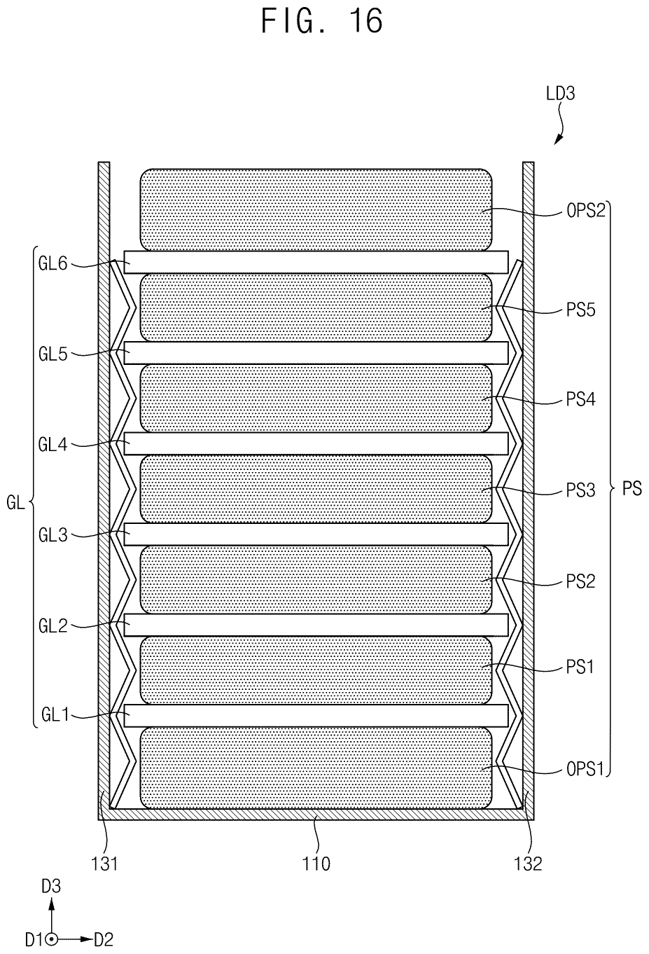

FIG. 14 is a perspective view illustrating a glass plate loading apparatus according to an embodiment, FIG. 15 is a side view of the glass plate loading apparatus shown in FIG. 14, and FIG. 16 is a side view of the glass plate loading apparatus shown in FIG. 14.

Referring to FIGS. 14 to 16, a plurality of glass plates GL may be loaded on the glass plate loading apparatus LD3. The glass plate loading apparatus LD3 may include a frame 100 and porous supports PS.

The glass plate loading apparatus LD3 may have substantially the same structure as the glass plate loading apparatus LD1 described above with reference to FIG. 1, except for a direction in which the glass plates GL and the porous supports PS are loaded and a direction in which the corresponding jigs 131 and 132 extend.

The glass plates GL loaded on the glass plate loading apparatus LD3 may be arranged parallel to each other in the third direction D3. Accordingly, the first jigs 131 and the second jigs 132 may extend from the support part 110 in the third direction D3.

The porous supports PS may be inserted between the glass plates GL. As the glass plates GL are arranged parallel to each other in the third direction D3, the porous supports PS may also be arranged parallel to each other in the third direction D3.

The glass plates strengthened by the glass plate loading apparatus and the method of manufacturing the glass plate according to embodiments of the present disclosure can be applied to various electronic devices. An electronic device according to embodiments may include a display device to which the aforementioned glass plate is applied and may further include modules or devices with additional functions other than the display device.

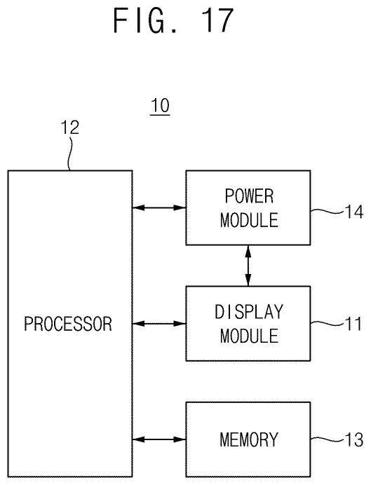

FIG. 17 is a block diagram of an electronic device according to an embodiment.

Referring to FIG. 17, the electronic device 10 may include a display module 11, a processor 12, a memory 13, and a power module 14.

The processor 12 may include at least one of a central processing unit (CPU), an application processor (AP), a graphic processing unit (GPU), a communication processor (CP), an image signal processor (ISP), and a controller.

The memory 15 may store data information required for operations of the processor 12 or the display module 11. When the processor 12 executes an application stored in the memory 15, a video data signal and/or an input control signal may be transmitted to the display module 11, and the display module 11 may process the received signal to output image information through a display screen.

The power module 14 may include a power supply module such as a power adapter, a battery device, and/or the like, and a power conversion module that converts the power supplied by the power supply module to generate power required for operations of the electronic device 10.

At least one of components of the electronic device 10 described above may be included within display devices according to embodiments described above. In addition, some of individual modules that are functionally included in one module may be included in the display device, while others may be provided separately from the display device. For example, the display device may include the display module 11 and the processor 12, the memory 13 and the power module 14 may be provided in the form of other devices within the electronic device 10 other than the display device.

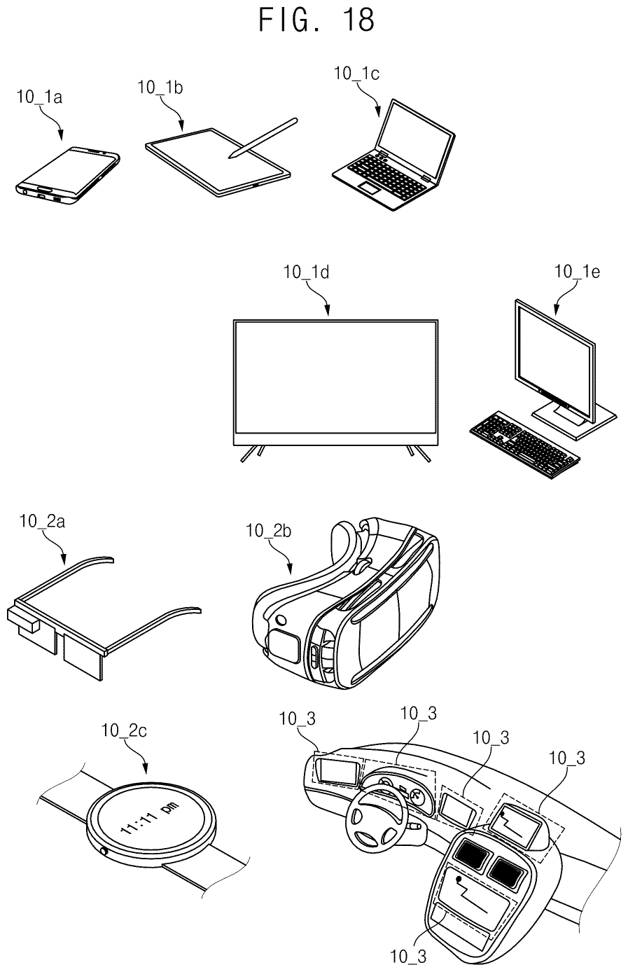

FIG. 18 are schematic diagrams illustrating various examples in which the electronic device of FIG. 17 is implemented.

Referring to FIG. 18, various electronic devices to which display devices according to embodiments are applied may include image display electronic devices such as a smart phone 10_1a, a tablet computer 10_1b, a laptop 10_1c, a television 10_1d, a desk monitor 10_1e, and/or the like, wearable electronic devices including display modules such as smart glasses 10_2a, a head-mounted display 10_2b, a smart watch 10_2c, and/or the like, and vehicle electronic devices 10_3 including display modules such as an automobile's instrument panel, a CID (Center Information Display) placed on center fascia and dashboard, a room mirror display, and/or the like.

The present disclosure may be applied to a display device and an electronic device including the display device. For example, the present disclosure may be applied to a smart phone, a cellular phone, a smart pad, a smart watch, a tablet computer, a vehicle navigation system, a television, a computer monitor, a laptop, and the like.

Although the present disclosure has been described above with reference to embodiments thereof, it will be understood by those skilled in the art that various modifications and changes can be made to the present disclosure without departing from the spirit and scope of the present disclosure as set forth in the following claims.

What is claimed is:

1. A glass plate loading apparatus, comprising:
a frame including a support part, a first wall connected to the support part, and a second wall connected to the support part and facing the first wall; and
a first porous support placed in a space between the first wall and the second wall and disposed between a first glass plate and a second glass plate loaded on the frame.

2. The glass plate loading apparatus of claim 1, wherein the first glass plate and the second glass plate are spaced apart from each other by the first porous support.

3. The glass plate loading apparatus of claim 1, wherein the first porous support is in contact with at least one of the first glass plate and the second glass plate.

4. The glass plate loading apparatus of claim 1, wherein a Mohs hardness of the first porous support is less than a Mohs hardness of the first glass plate and a Mohs hardness of the second glass plate.

5. The glass plate loading apparatus of claim 1, wherein the first porous support has a porous structure in which a plurality of pores are defined.

6. The glass plate loading apparatus of claim 5, wherein a porosity of the first porous support is between 50% and 90%.

7. The glass plate loading apparatus of claim 1, wherein the first porous support includes at least one selected from a group consisting of polyurethane foam, polystyrene, silica aerogel, polypropylene, aluminum foam, and polyvinyl alcohol.

8. The glass plate loading apparatus of claim 1, wherein the first porous support does not chemically react with a strengthening solution that strengthens the first and second glass plates.

9. The glass plate loading apparatus of claim 1, wherein the first porous support is not deformed at a strengthening temperature for strengthening the first and second glass plates.

10. The glass plate loading apparatus of claim 1, wherein the first porous support covers a portion of the first glass plate and a portion of the second glass plate.

11. The glass plate loading apparatus of claim 1, wherein the first porous support includes:
a first-first porous support covering a first area of the first glass plate; and
a first-second porous support covering a second area of the first glass plate, the second area being spaced apart from the first area.

12. The glass plate loading apparatus of claim 11, wherein the first porous support does not cover a folding area defined between the first area and the second area.

13. The glass plate loading apparatus of claim 1, further comprising:
a second porous support placed in the space between the first wall and the second wall and disposed between the second glass plate and a third glass plate loaded on the frame.

14. The glass plate loading apparatus of claim 1, further comprising:
an outer porous support disposed between the first wall and the first glass plate.

15. A method of manufacturing a glass plate, the method comprising:
preparing a frame including a support part, a first wall connected to the support part, and a second wall connected to the support part and facing the first wall;
loading a plurality of glass plates on the frame;
inserting a plurality of porous supports into the frame; and
performing a strengthening process on the glass plates.

16. The method of claim 15, wherein each of the plurality of porous supports is disposed between adjacent ones among the plurality of glass plates, and
wherein the adjacent glass plates are spaced apart from each other by at least one porous support among the plurality of porous supports.

17. The method of claim 15, wherein the plurality of porous supports are inserted after the plurality of glass plates are loaded on the frame.

18. The method of claim 15, wherein the performing the strengthening process includes:
performing a pre-heating process during which the plurality of glass plates are heated to a first strengthening temperature;
performing an ion exchange process during which the plurality of glass plates are immersed in a strengthening solution; and
performing a post-heating process during which the plurality of glass plates are heated to a second strengthening temperature.

19. The method of claim 18, wherein the plurality of porous supports do not chemically react with the strengthening solution.

20. The method of claim 18, wherein the plurality of porous supports are not deformed at the first strengthening temperature and the second strengthening temperature.
